(19) United States
(12) Patent Application Publication
(10) Pub. No.: US 2005/0125821 A1
(43) Pub. Date: Jun. 9, 2005

(54) Method and apparatus for characterizing a video segment and determining if a first video segment matches a second video segment

(76) Inventors: Zhu Li, Palatine, IL (US); Bhavan R. Gandhi, Vernon Hills, IL (US); Aggelos K. Katsaggelos, Chicago, IL (US)

Correspondence Address: MOTOROLA, INC., 1303 EAST ALGONQUIN ROAD, IL01/3RD, SCHAUMBURG, IL, 60196, US

(21) Appl. No.: 10/990,583

(22) Filed: Nov. 17, 2004

Related U.S. Application Data
(60) Provisional application No. 60/523,015, filed on Nov. 18, 2003.

(51) Int. Cl. H04B 1/66; H04N 7/16; H04N 11/04; H04N 11/02

(52) U.S. Cl. 725/19; 375/240.27; 382/181; 382/173

(57) ABSTRACT

A method and apparatus for determining if a first video segment matches a second video segment is provided herein. Each video segment to be compared has an associated metric (H_{R}), which is a function over time as the conditional entropy between frame fₖ and previous frame fₖ₋₁. A comparison of each video segment's H_{R} vectors determines if the video segments match.

### FIELD OF THE INVENTION

The present invention relates generally to video processing and retrieval, and in particular, to a method and apparatus for characterizing a video segment and determining if a first video segment matches a second video segment.

### BACKGROUND OF THE INVENTION

With the proliferation of digital video capturing and storage devices, the amount of information in video form is growing rapidly. Effectively sharing and managing video content presents a technical challenge to existing information management systems. Traditional methods for managing media content are by simple labeling and annotation. This may work in certain applications where a small number of video files need to be managed, but for situations where large numbers of files need to be managed, an automatic, “content-based” approach is more appropriate. “Content-based” approaches require minimum human intervention as compared with manual labeling and annotation approach.

Consider a situation where a mobile phone user may want to search for a sports TV program from a short and small sized clip they viewed on their cellular telephone. The small clip might be a 10 second half-time show in a football game, and the user may wish to determine which football game the clip belongs to, from possibly hundreds of football games. While there exists methods for matching still images (e.g., pictures), there currently exists no adequate method or apparatus for matching video segments. Furthermore, such a video segment matching method should be both temporal and spatial scale invariant. This allows using video clips of a different picture size and different temporal rate to find the best match in the database.

### BRIEF DESCRIPTION OF THE DRAWINGS

FIG. 1 is a block diagram of an apparatus for determining if a first video segment matches a second video segment.

FIG. 2 is a flow chart showing the operation of the apparatus of FIG. 1.

FIG. 3 shows a graphical comparison between two frames.

### DETAILED DESCRIPTION OF THE DRAWINGS

To address the above-mentioned need, a method and apparatus for characterizing a video segment and determining if a first video segment matches a second video segment is provided herein. Each video segment is represented with an associated scalar characteristic function H_{R}(k), which is a function of time, k. The characteristic function, H_{R}(k), of an example video segment is compared with the characteristic functions of the video segments in a database to determine the best match according to a predetermined cost function (i.e., match metric).

Recently the Motion Pictures Expert Group (MPEG) consortium defined certain characteristics associated with image and video data. These characteristics are currently being standardized in MPEG-7, and are called visual Descriptors (D). Some of the visual descriptors are defined as follows:
Color Layout D (CLD) sub-samples images and represents them as an 8×8 sub-image, this sub-image is then transformed into a spatial frequency representation using the discrete cosine transform (DCT).
Scalable Color D (SCD) transforms an image into the Hue Saturation Value (HSV) color space and then computes a histogram using 1024 uniformly quantized (partitioned) bins. This color histogram is Haar transformed and further quantized to produce the SCD representation.
Dominant Color D (DCD) is an estimation of color distribution in RGB color space. The number of representative color clusters are not predetermined or fixed, which makes DCD a compact representation of color distribution of an image.
Motion Activity D (MAD) characterizes the level of motion activity in a frame of a video sequence. It is computed from the variance of the motion vector magnitudes in the frame of a video sequence.

With the exception of MAD, MPEG-7 visual Ds are designed for still image retrieval. MAD is designed for measuring the activity level of individual frames within a video sequence.

For video content, there is a temporal dimension that is not well represented by the above-mentioned visual Ds. Even though SCD can be used for a video sequence, the SCD would have to be computed from all frames. Whenever a frame is added, removed or shifted in/out of the clip, the SCD would have to be re-computed from all frames again, which makes the sequence matching process computationally prohibitive.

Also for computational complexity reasons, a solution of computing and using the CLD or DCD for each frame in a sequence is also not feasible. An efficient representation that captures the temporal behavior of video sequences is needed other than those discussed above. A problem also exists with using MAD for representing temporal behavior. MAD does not adequately capture changes such as lighting conditions and camera motion. Therefore, none of the existing MPEG-7 visual descriptors are adequate in producing a quick determination if video segments match.

The characteristic function H_{R}(k) adequately represents the temporal behavior of a video segment. H_{R}(k) can be obtained through various means. In the preferred embodiment of the present invention, H_{R}(k) is obtained by a first computing a Principal Component Feature (PCF) representation of each video frame and then computing the weighted distance, D_{W}, between the PCF representations of frames at time instance k, with frames at time instance k−1. This is shown in Equation (1).

$${H}_{R} ( k ) = \{ \begin{matrix} 0 , & if k = 1 \\ {D}_{W} [ PCF ( {f}_{k} ) , PCF ( {f}_{k - 1} ) ] , & if k > 1\end{matrix} \} \qquad ( 1 )$$

As a practical implementation, an approximation to computing the PCF of a frame can be achieved by computing the CLD of the frame. This yields a scalar function representation of the video sequence temporal behavior with spatially invariance. A similar H_{R} function will exist for video sequences in different image (frame) size.

The Video Browsing Descriptor (VBD) is defined for each video shot, S, as a tuple of the representative video characteristic function (H_{R}), key frame feature (X), frame rate (fps) or the representative timestamps (ts) for the frames, and total number of frames in the video shot (n),
VBD(S)={n, fps or ts, X, H_{R}}. (3)
The characteristic function H_{R} is stored as an n-dimensional vector, the key frame feature X can be any combination of the still image features mentioned above (CLD, SCD, DCD and MAD), and fps or ts gives the time change between any two frames in the shot.

The matching of video shots is done through a matched filter like operation on their characteristic functions. In other words, a determination if video segments match can be done by passing the video characteristic function H_{R} for the second video segment through a matched filter comprising the video characteristic function H_{R} for the first video segment. When determining if a querying video shot Q matches part or all of a clip V from collections their VBDs are computed if not present. Then their characteristic functions are pre-processed according to the timestamp or fps information within the respective VBDs. The purpose is to align their temporal scales. Thus providing temporal scale invariance.

The video characteristic function of Q is used to build the matched filter. V's video characteristic function is passed through the matched filter and spikes are detected in the filter output. If there is a spike greater than a predetermined threshold, the sequence is found. In other words, if there exists a spike greater than the predetermined threshold, clip Q is found within clip V. If multiple spikes are detected and there is an ambiguity in decision, the key frame features X can be used in additional matching in order to eliminate any false alarms.

Thus, when comparing two characteristic functions a scalar value is returned indicating the distance between two sequences that are represented by their characteristic functions. The matching is primarily computed from the video characteristic function H_{R} through a matched filter like structure. For a query example sequence Q with m frames, and a video database V with n frames, and n>m, the querying result S is the location of querying sequence Q in video database V,

$$S = V [ {k}^{*} : {k}^{*} + m - 1 ] , where \\ {k}^{*} = arg {min}_{k ∈ [ 1 , n - m ]} d \text{(} {H}_{R}^{Q [ 1 : m ]} , {H}_{R}^{V [ k : k + m - 1 ]} \text{)} \qquad ( 4 )$$

The distance function d(H_{R}^{Q}, H_{R}^{V}) between two characteristic function in (4) can be computed using either L₁ or L₂ match metric. L₁ match metric computes the sum of absolute difference between the characteristic functions; while L₂ match metric computes the square of difference. Let the characteristic function of the query clip Q be [q₁, q₂, . . . qₘ], and let the characteristic function of the video data base clip V be [v₁, v₂, . . . vₙ], then the distance function is computed as,

$$d \text{(} {H}_{R}^{Q [ 1 : m ]} , {H}_{R}^{V [ k : k + m - 1 ]} \text{)} = \{ \begin{matrix}{\sum }_{j = 1}^{m} \vert {q}_{j} - {v}_{j + k} \vert , & {L}_{1} case \\ {\sum }_{j = 1}^{m} {\vert {q}_{j} - {v}_{j + k} \vert}^{2} , & {L}_{2} case\end{matrix} \} . \qquad ( 5 )$$

Temporal scale variance can be addressed by pre-computing the characteristic function H_{R} for the video clips in the database at different temporal scales. One can reasonably assume that the frame rate varies in limited scales, for example, 10 fps, 15 fps, 20 fps and 30 fps. If a querying clip is obtained with a particular frame rate, the characteristic function is then chosen with the right frame rate to match with on the data base side.

Irregular dropping of frames in video clips or other forms of noise require additional processing of the characteristic function. There are three methods to achieve temporal scale invariance. The first method is to increase the length n of the querying sequence when it is available. An H_{R} functional with a larger n is more resistant to the distortion introduced by the dropped frames. The second method can use frame image features like CLD, DCD and SCD to eliminate false matches.

The third and most effective method interpolates the H_{R}( ) function for the missing frames. If m consecutive frames are missing from the querying clip, i.e., frames k to (k+m−1). The interpolation method takes the observed characteristic function value at the time instant k+m, H_{R}(k+m), and splits it equally between the time instances k to (k+m−1). This results in the interpolated characteristic function values at H′_{R}(k) to H′_{R}(k+m), and is shown in Equation (6),

$${H}_{R}^{′} ( k + i ) = \frac{{H}_{R} ( k + m )}{( m + 1 )} , 0 \leq i \leq m \qquad ( 6 )$$

Note, all indices of time are refereeing to the interpolated frame time in (6). For small m in range of 1 to 4, this method is effective because of the typical trajectory of the video sequences is smooth locally, and the distance value is interpolated at equally spaced points in temporal dimension.

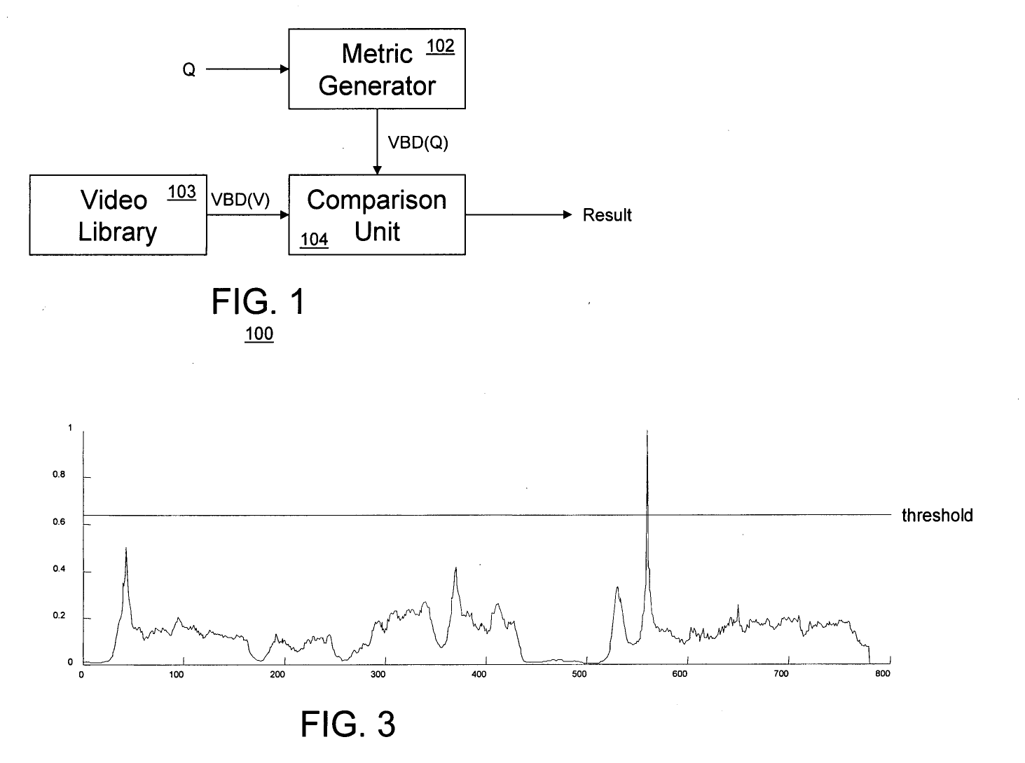

Turning now to the drawings, wherein like numerals designate like components, FIG. 1 is a block diagram of apparatus 100 for determining if a first video segment (Q) matches a second video segment (V). As shown, apparatus 100 comprises metric generator 102 receiving video segment Q, video library 103 outputting a VBD for video segment V, and comparison unit 104 determining if a match exists between segments Q and V, and outputting the result.

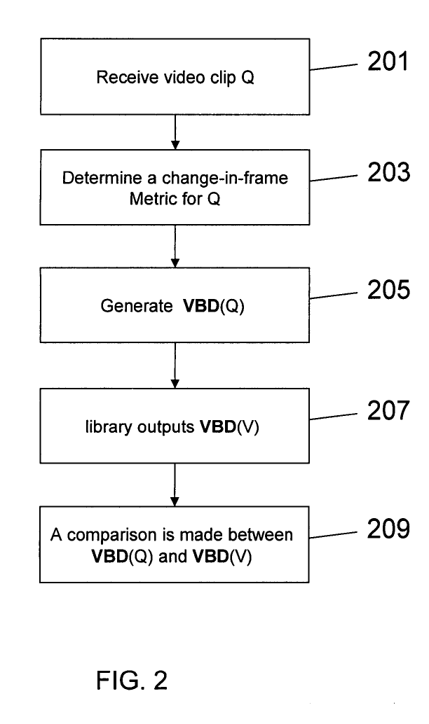

Operation of apparatus 100 occurs as shown in FIG. 2. In particular, FIG. 2 is a flow chart showing operation of apparatus 100. The logic flow begins at step 201 where metric generator 102 receives video clip Q and determines frame characteristics for each frame within clip Q. In the preferred embodiment of the present invention the frame characteristic for a frame is a change in a PCF between the frame and the prior frame. At step 203, metric generator 102 generates a metric based on video clip Q. As discussed above, the metric comprises a vector H(Q)=(H_{R}(f_{N}), H_{R}(f_{N-1}), . . . H_{R}(f₂), H_{R}(f₁)), having a change in frame characteristic H_{R} for each frame within clip Q. Thus, the video clip is represented as a series of changing frame characteristics, with H_{R}(fₓ) representing a change frame characteristic between frame x and frame x−1. Additionally, in the preferred embodiment of the present invention, the frame characteristic is preferably change in CLD so that:

$${H}_{R} ( {f}_{k} ) = \{ \begin{matrix} 0 , & if k = 1 \\ {‖ CLD ( {f}_{k} ) - CLD ( {f}_{k - 1} ) ‖}^{2} , & if k ∈ [ 2 , n ]\end{matrix} \}$$

however, in alternate embodiments of the present invention the frame characteristic can be any characteristic taken from the group consisting of CLD, SCD, DCD, and MAD.

Continuing, once metric generator generates H(Q), VBD(Q) is generated by generator 102 at step 205 such that the video segment Q can be characterized by:
VBD(S)={n, fps, X, H_{R}}.

At step 207 video library 103 outputs VBD(V) to comparison unit 104. Thus comparison unit 104 receives both the first and the second video segments, each represented as a series of changing frame characteristics. At step 209 a comparison is made between VBD(Q) and VBD(V). It should be noted that the length of each video clip to be compared may be similar or different. If similar, a simple comparison of each VBD value is made for each clip, however, if different, a comparison is made by determining if the shorter video segment matches any portion of the larger video segment.

Continuing, the result of the comparison is primarily driven by similarities/differences in H_{R} (series of changing frame characteristics) between video clips Q and V. As discussed above, when comparing two VBDs a scalar value is retuned indicating the distance between two sequences that are represented by VBDs. If the scalar value is above a threshold, the result is a match.

FIG. 3 is a graphical representation of the scalar value returned when comparing a simulated video clip Q to a video clip V containing Q. In other words, video clip Q is shorter in length than video clip V. As is evident, a spike occurs around frame 575 indicating a possible match between clip Q and V around frame 575. Therefore, video clip Q is contained within video clip V around frame 575.

It should be noted that there may exist situations where frames within a video clip are corrupted or missing. For this situation, simple generation of H_{R} will result in misleading values for H. This situation can be accommodated by pre-computing the VBD at different scales for database side data. Since it can reasonably be assumed that the temporal scale exists in only a limited set, like {40 fps, 30 fps, 20 fps, 15 fps, 10 fps}, a query can be run across these scales. If frames have been arbitrarily dropped from the sequences used for the querying example, the method depicted in the equation (6) may be employed to interpolate the missing frames.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for determining if a first video segment matches a second video segment, the method comprising the steps of:
representing the first video segment as a first series of changing frame characteristics;
representing the second video segment as a second series of changing frame characteristics; and
determining if the first video segment matches the second video segment by determining if the first and the second series of changing frame characteristics match.

2. The method of claim 1 wherein the step of representing the first and the second video segments as a series of changing frame characteristics comprises the step of representing the first and the second video segments as a series of changing characteristics taken from the group consisting of CLD, SCD, DCD, and MAD.

3. The method of claim 1 wherein the step of determining if the first video segment matches the second video segment comprises the step of determining if the first video segment matches any portion of the second video segment.

4. The method of claim 1 wherein the step of determining if the first video segment matches the second video segment by determining if the first and the second series of changing frame characteristics match additionally comprises the step of determining if a key frame features X, a frame rate, a timestamps for frames, and a total frames in each video segment matches.

5. The method of claim 1 further comprising the steps of:
determining if the first or the second video segments comprise noise; and
increasing a length of a querying sequence when noise is available.

6. The method of claim 1 further comprising the steps of:
determining if the first or the second video segments comprise noise; and
using an information invariance principle to interpolate changing frame characteristics for missing frames.

7. A method comprising the steps of:
receiving a first video segment;
determining a Video Browsing Descriptor (VBD) for the first video segment, wherein the VBD comprises a video characteristic functional H_{R} for the first video segment defining a change in frame characteristics for the first video segment;
receiving a VBD for a second video segment; and
determining if the first video segment is contained within the second video segment by determining a distance between the VBD for the first video segment and the VBD for the second video segment.

8. The method of claim 7 wherein the step of determining if the first video segment is contained within the second video segment further comprises the step of passing the video characteristic function H_{R} for the second video segment through a matched filter comprising the video characteristic function H_{R} for the first video segment.

9. The method of claim 7 wherein the step of determining the VBD for the first video segment comprises the step of determining a tuple of video characteristic functional H_{R}, key frame features X, frame rate frames per second, and total frames in the first video segment.

10. A method for characterizing a video segment, the method comprising the steps of:
determining a frame characteristic for each frame of the video segment;
determining a change in frame characteristics between frames of the video segment; and
characterizing the video segment as a change in frame characteristics between frames of the video segment.

11. The method of claim 10 wherein the step of determining the frame characteristic comprises the step of determining a characteristic from the group consisting of CLD, SCD, DCD, and MAD.

12. An apparatus comprising:
a metric generator receiving a first video segment (Q) and outputting an video characteristic function for the first video segment, wherein the video characteristic function comprises a series of changing frame characteristics for the first video segment (VBD(Q)); and
a comparison unit receiving VBD(Q) and additionally receiving a series of changing frame characteristics for a second video segment (VBD(V)) and outputting a determination of whether the first video segment is contained within the second video segment.

13. The apparatus of claim 12 wherein the series of changing frame characteristics comprises a series of changing characteristics taken from the group consisting of CLD, SCD, DCD, and MAD.

14. The apparatus of claim 13 wherein VBD(Q) and VBD(V) additionally comprise a key frame features X, a frame rate, a timestamps for frames, and a total frames in each video segment.

15. The apparatus of claim 12 wherein the comparison unit determines if the first video segment is contained within the second video segment by determining a distance between the VBD for the first video segment and the VBD for the second video segment.

16. An apparatus comprising:
a metric generator receiving a video clip, and outputting a characterization of the video clip as a series of changing frame characteristics.

17. The apparatus of claim 16 wherein the series of changing frame characteristics comprises a series of changing characteristics taken from the group consisting of CLD, SCD, DCD, and MAD.

18. The apparatus of claim 17 wherein the characterization additionally comprises a key frame features X, frame rate frames per second, and total frames in the first video segment.
